(19) United States
(12) Patent Application Publication
(10) Pub. No.: US 2010/0221500 A1
(43) Pub. Date: Sep. 2, 2010

(54) METHOD FOR PRODUCING ELONGATED PROFILES OR STRIPS FROM SOLIDIFIED MOLDING COMPOUNDS IN A MOLD, AND MOLD FOR PERFORMING THE METHOD

(76) Inventors: Gottfried Steiner, Spielberg (AT); Thomas Krivec, Zeltweg (AT)

Correspondence Address: OSTROLENK FABER GERB & SOFFEN, 1180 AVENUE OF THE AMERICAS, NEW YORK, NY, 100368403, US

(21) Appl. No.: 12/680,660

(22) PCT Filed: Sep. 22, 2008
(86) PCT No.: PCT/EP08/62626

§ 371 Date: Mar. 29, 2010

(30) Foreign Application Priority Data
Sep. 28, 2007 (AT) 1545/2007

(51) Int. Cl. B29C 45/56; B29C 45/04; B29C 45/26; B32B 3/26

(52) U.S. Cl. 428/174; 264/328.7; 425/149

(57) ABSTRACT

A method for the production of elongated profiles or ledges (21) out of solidifying compounds in a mold with at least one lower part and at least one upper part, the molding compound (20) being continuously injected into the mold cavity (4), with the injected molding compound (20) being transported away from the gating point(s) and out of the mold under steady extension of the mold cavity (4) and under steady elongation of the forming profile or ledge (21) by relative movement of mold components and wherein molding compound (20) is injected until the profile or ledge (21) reaches its designated length.

In order to manufacture particularly high class profiles and ledges, at the beginning of the injection process the molding compound (20) fills up an end section (4a) of the cavity (4) of the profile or ledge (21) to be formed, said cavity being closed in direction of the exit of the profile, beyond the gating point (3), wherein beyond the gating point (3) due to the process pressure the front section of the molding compound (20) during the relative movement of the mold components remains in position as free front section (20a) of the molding compound (20) with reference to the upper mold part, wherein the mold cavity (4) is filled up while molding compound (20) is transported away from the gating point (3) and out of the mold.

A method for the production of elongated profiles or ledges out of solidifying compounds in a mold with at least one lower part and at least one upper part, the molding compound being continuously injected into the mold cavity, wherein the injected compound is transported away from the gating point(s) and out of the mold under steady extension of the mold cavity and under steady elongation of the forming profile or ledge by relative movement of mold components and wherein molding compound is injected until the profile reaches its pre-defined length.

Furthermore a mold for the production of elongated profiles or ledges out of solidifying molding compounds with at least one lower part and one upper part, wherein at one of the parts of the mold a gating insert is located and at the other a profiled mold insert is located that determines the geometry of the profile or ledge at least to a large extend and that is a part of the mold cavity, wherein the profiled mold insert and the part of the mold comprising the gating insert can be moved relatively to each other in direction of the longitudinal axis of the mold such that by this movement the profile or ledge can be produced inside and outside of the mold in the designated length.

A process and a device of the herein before mentioned type are known from WO-A-2006/045720. There a cavity formed between mold components of the upper and the lower mold part is filled with moulding compound, after initial filling of the cavity and under continued injection of new molding compound the injected molding compound is steadily transported away and out of the mold under extension of the shaping area and under extension of the profile to be formed.

It is representative for the known process and the know mold that after volumetrical filling of the initial cavity the resulting molding part steadily grows or is steadily formed, respectively, directly at the gating point of the cavity and not at the melt front as it is the case at conventional injection molding.

During the injection process the injected and slowly solidifying molding compound, that forms the profile is steadily transported away from the gating area. The process distinguishes from a conventional extrusion process mainly by the possibility to manufacture profiles of a designated length whose geometries are not that restricted as at a conventional extrusion process.

The U.S. Pat. No. 3,992,503 illustrates a method for the production of ribbed tube out of thermoplastic material. There a section of a tube is produced in an injection molding process in a mold cavity formed by two halves of a so that the desired ribbing is formed on the outer surface of the tube. After solidification of the tube section, the outer part of the mold is removed and the set tube section is shifted in longitudinal direction. Then the outer part of the mold is re-positioned such that a mold cavity for molding the next section of the tube is formed in a closed position. The process steps are repeated until the tube reaches the desired length. A further similar process for the production of tubular components in sections, which is based on a similar method, is known from EP 0 018 044 A1.

The primary task of the present invention is, to further improve the process known from WO-A-2006/0405720 and the known mold, especially to manufacture particularly high quality profiles and ledges of a designated length.

As far as the method is concerned, these and other objects of the present invention are attained in such a way that at the beginning of the injection an end section of the mold cavity, that is closed in the direction the resulting profile or ledge is transported out of the mold, is filled up by the molding compound beyond the gating point, wherein, while there is relative movement of the mold components, the flow front of the molding compound due to the process pressure remains as a free front section in position compared to the upper part of the mold, wherein the mold cavity is filled up while molding compound is transported away from the gating point and out of the mold.

As far as the mold is concerned, the objectives of the present invention are attained in such a way that the profiled mold insert possesses a length that corresponds to the length of the profile or ledge to be manufactured and together with the mold part comprising the gating insert only at the beginning and at the end of the injection process forms closed cavity sections.

At the process according to the invention and with the device in accordance with the invention at the beginning of the injection process only the frontal end section of the cavity is filled, at the second end section the mold cavity initially remains open. During the injection process the free melt front remains in position in relation to the upper part of the mold. The rear end section of the cavity is filled not until the end of the injection process. Due to the free melt front it is possible to produce particularly high quality profiles and ledges.

At a preferred and a particularly advantageous embodiment of the invention the free front section of the injected molding compound is separately tempered. This measure allows to keep the free front section of the molding compound on a temperature level that ensures proper flowing of the molding compound away from the gating point and such the generation of particularly high quality profiles.

The free front section of the injected molding compound can be tempered in a constant manner or variably which would particularly advantageous affect the quality of the profile or ledge.

In the mold part comprising the gating insert the mold in accordance with the invention contains a tempering element that gets in contact with the injected molding compound and thus provides a constant or variable tempering of the free front section of the injected molding compound. The tempering element preferably extends on both sides of the gating point and can be cooled in front of the gating point in order to support the solidifying process of the profile or ledge being transferred out of the mold.

In order to be able to manufacture profiles or ledges of defined lengths in a mold it can be considered as advantageous if the profiled mold part comprises a movably supported carriage comprising a profiled insert with a single-part or multi-part design.

Furthermore at the area where the resulting profile or the resulting ledge exits the mold the mold can contain a unit for aftertreatment, especially for smoothing, of the free surface of the profile or ledge being transported out of the mold. This after-treatment can be realized in different ways for example with infra-red radiation, ultra sonic treatment, flame treatment or mechanical finishing.

Moreover the invention relates to a component, especially a profile or a ledge, which is manufactured applying a process in accordance with one or more of the process claims

Additional design features, advantages and details of the invention will now be described, by the way of example, with reference to the accompanying drawing wherein

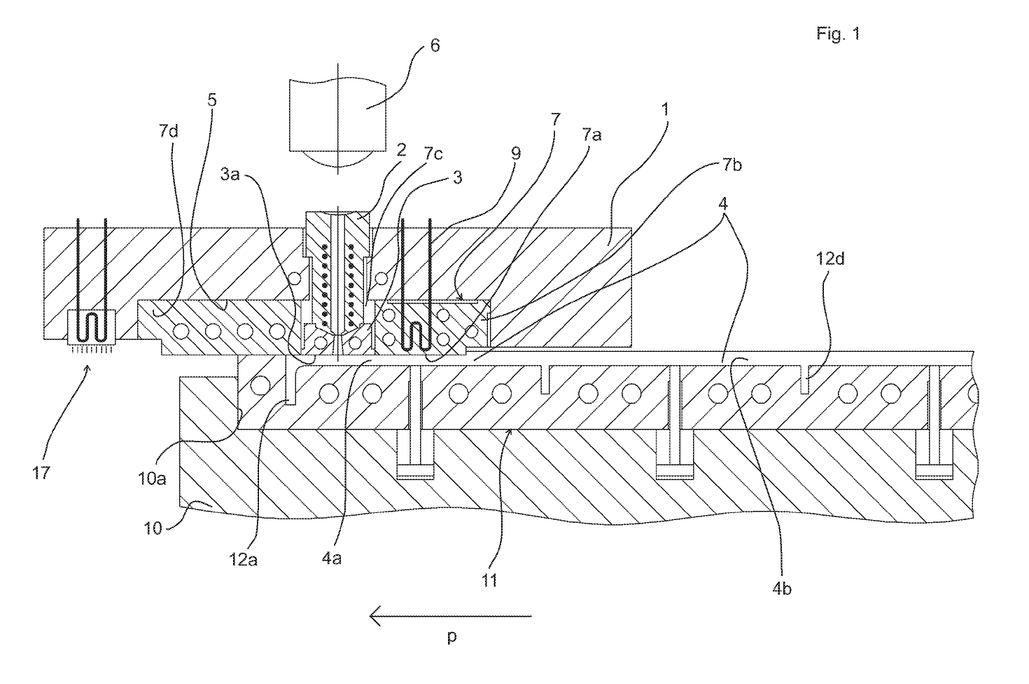

FIG. 1 is a longitudinal cross sectional view of an injection mold in accordance with the present invention,

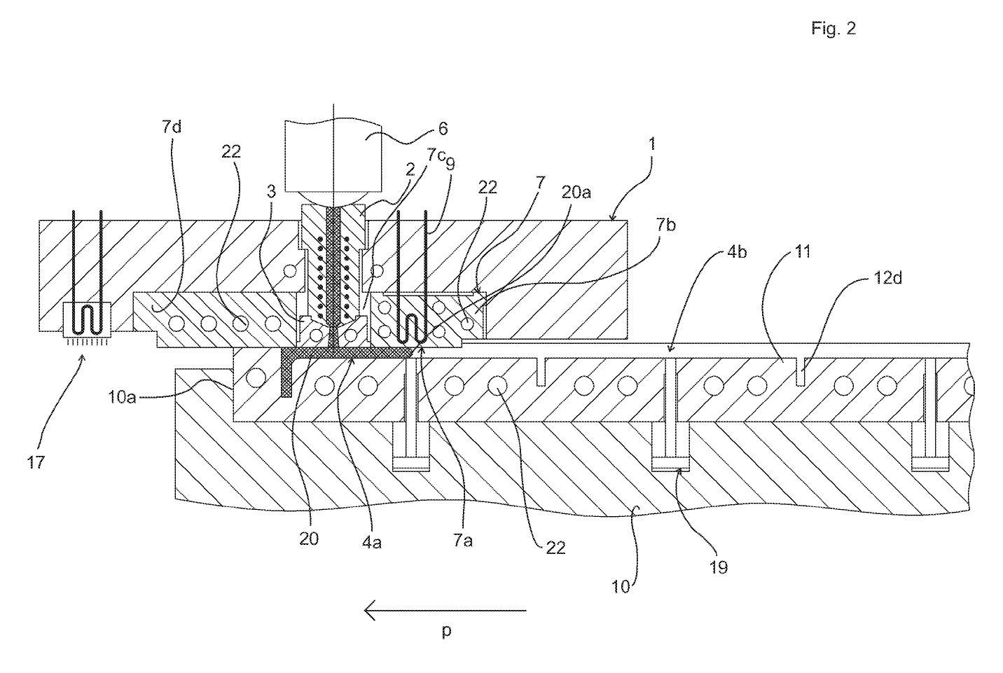

FIG. 2 to FIG. 7 are longitudinal cross sectional views in analogy to that shown in FIG. 1 at different stages of the injection process and of the manufacturing of a profile or ledge, respectively.

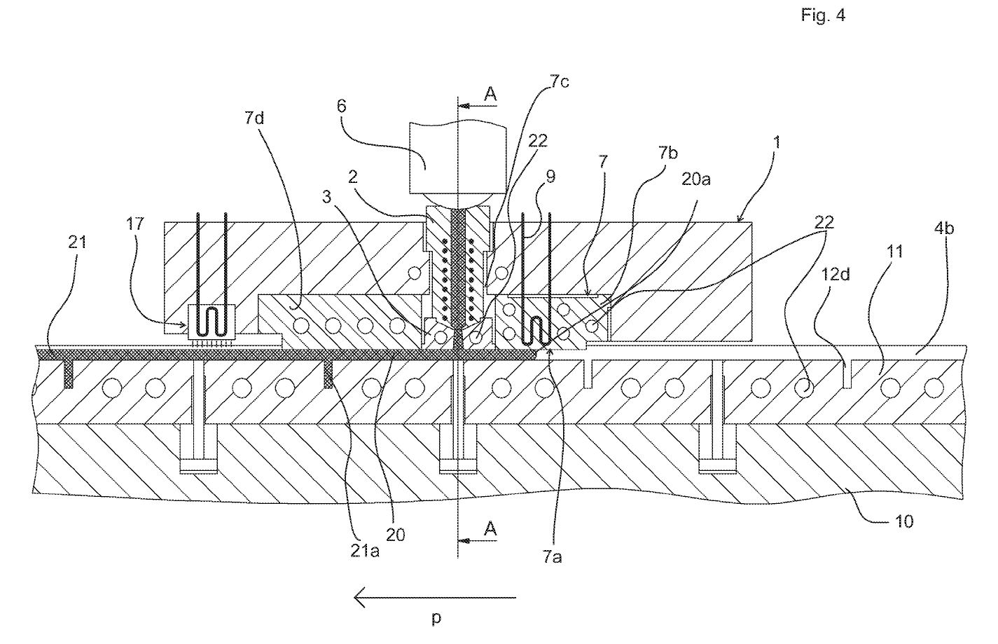

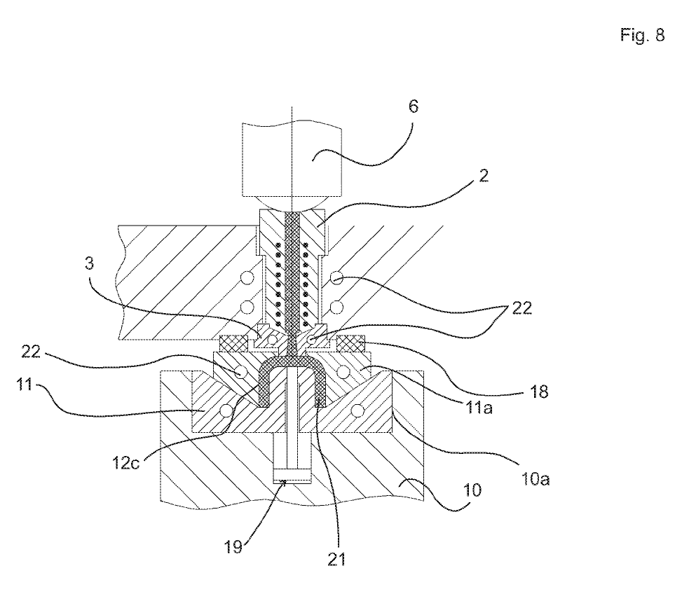

FIG. 8 is a cross sectional view taken about on line A-A of FIG. 4,

The mold in accordance with the invention consists of a first or upper part of the mold and a second or lower part of the mold, which mold parts are moveable away from each other and towards each other in order to open and close the mold. The upper part of the mold comprises a mold insert 1, which is in a manner not shown, mounted at a fixing plate or similar of the upper mold part. A hot runner nozzle extends through the mold insert 1 followed by a gating insert 3 from which the molding compound deliverable by a injection unit 6 exits into the mold cavity 4 which will later be described in detail. The unit 6 can be an injection unit of a injection molding machine or a processing unit of an extruder. The gating insert and the end section of the hot runner nozzle 2 related to it are positioned in a central opening 7c of a tempering element 7 positioned in a flat recess of the mold insert 1. In the described implementation the tempering element 7 is designed as a multipart plate said insert tightly fit into the recess 5 wherein its flat outer surface 7a which is directed against the lower part of the mold and together with the flat outer surface 3a of the gating insert 3 forms the boundary the mold cavity 4. The multipart tempering element 7 comprises a part 7d that can be cooled in front of the gating insert and a part that is able to be heated or cooled behind the gating insert, which is symbolized by the heating element 9 shown in the figures. The gating insert 3 and the part 7d of the tempering element 7 are designed as combined extrusion die with calibration zone, wherein the gating insert 3 preferably has the function of the extrusion die while the part 7d preferably implements the function of the calibration unit.

As described more detailed later elongated profiles or ledges are manufactured with the process in accordance with the invention, wherein at the beginning of the injection process with the mold in closed position the molding compound enters a closed end section 4a of the mold cavity generated inside the mold, that passes into a elongated mold section 4b, corresponding to the length of the profile or ledge to be produced, said elongated section being outside the upper mold part and the upper mold insert 1, respectively. At the beginning of the injection process, with the mold just closed, the closed end section 4a is positioned just before the gating insert 3.

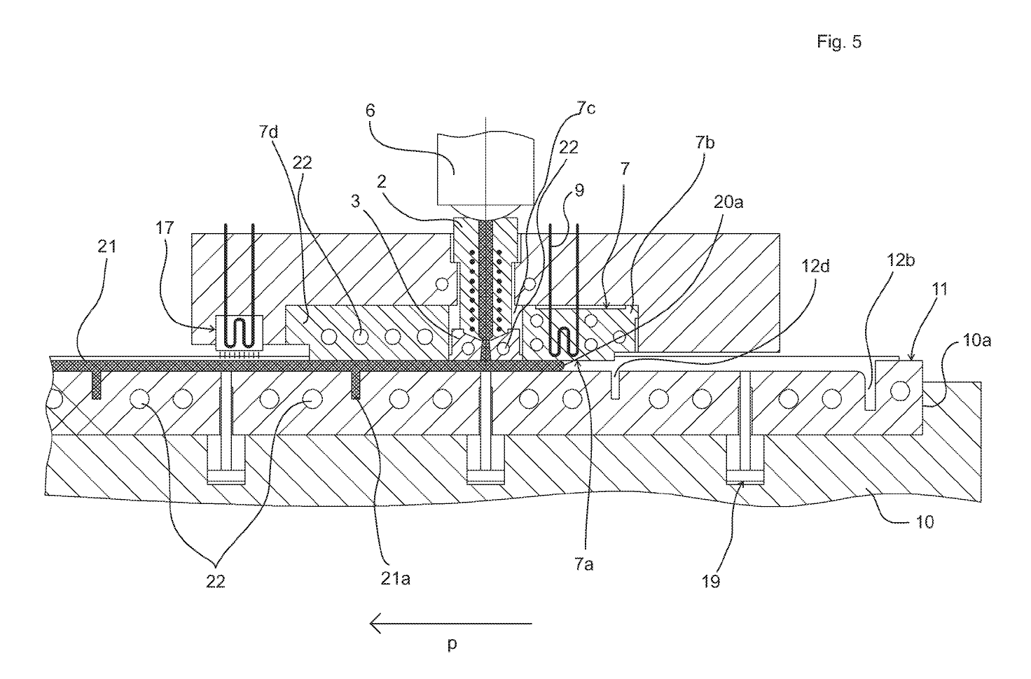

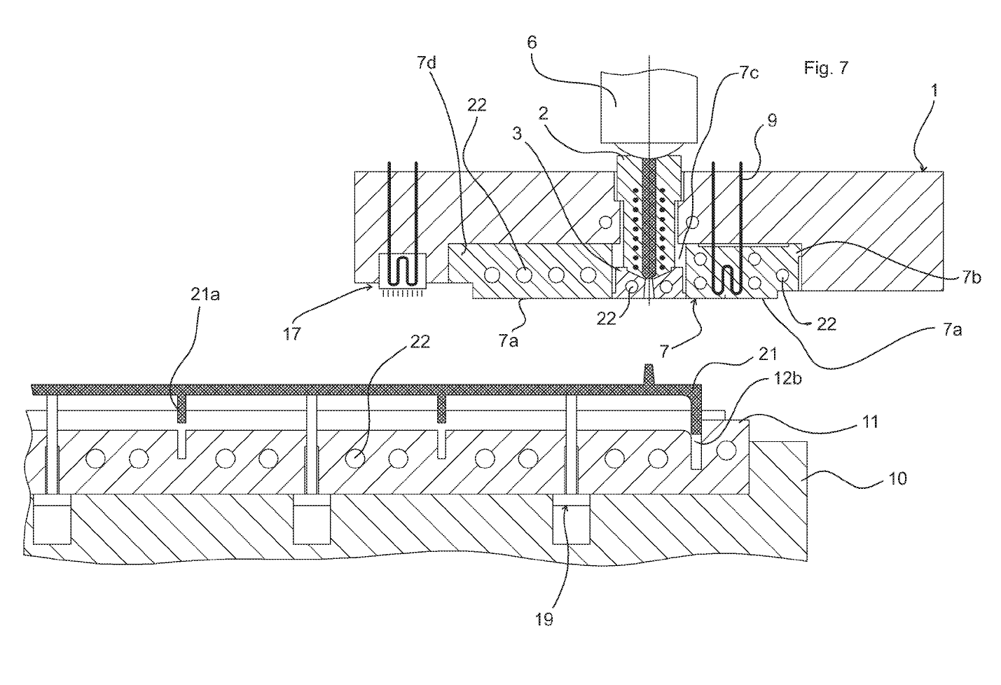

The lower part of the mold comprises a profiled mold insert, which in the implementation described above, comprises an elongated carriage 10 supported movably in its longitudinal direction at a mold plate not shown in the figure or similar, the carriage having a longitudinal recess 10a in which contains an also longitudinal carriage insert 11. The carriage insert 11 determines the geometrical shape of the resulting profile or the resulting ledge 21, respectively and together with the carriage 10, the tempering element 7 and the gating insert 3 forms the boundary of the the closed end section 4a of the mold cavity 4. Beyond the end section 4a the carriage insert 11 together with the carriage 10 forms the longitudinal cavity section 4b, that is open on its upper side. As FIG. 1, FIG. 7 and FIG. 8 show at the implementation described a profile or a ledge, e.g. a long, straight ledge with end caps and a U-shaped cross section, is formed by the design of the geometry of the single parts, especially the carriage insert 11 and the carriage 10. Recesses 12a (FIG. 1) and 12b (FIG. 5) at the end sections of the carriage inset 11 are designated for the formation of the end caps and connect L-shaped voids 12c (FIG. 8) which are formed between the carriage 10 and the insert 11 and which form the side sections of the profile and the ledge 21, respectively. Additional recesses 12d allow the generation of ribs or cross beams 21a at the profile or the ledge, respectively. As shown in FIG. 8 the carriage insert 11 comprises jaws 11a, which are kept in position by the clamping force applied, so that the cavity is geometrically fixed during the injection process in order to accommodate the cavity pressure. Alternatively an embodiment of the invention can be described where the jaws 11 a are not fixed by the clamping pressure over the supporting sliding elements 18 but the jaws 11 a are latched in the carriage insert 11. In accordance with the state of the art this latching can be done applying mechanical, hydraulic or pneumatic latching devices. A latching of the jaws 11a in the carriage insert 11 as described is particularly reasonable and necessary if the mold for the process in accordance with the invention is indented as an extrusion die for a use in combination with an extruder.

Next to the tempering element 7 at the implementation described an after treatment unit 17 is integrated. As FIG. 8 shows there are sliding elements 18 operative between the carriage insert 11 and the mold insert 1, that enable a relative movement between the carriage insert 11 and the mold insert 1 even if there is clamping pressure applied. The sliding elements 18 can be carried out as massive elements with or without anti-friction coatings as ball bearings, roller-bearing or needle bearings or suchlike.

In the mold insert 1, the tempering element 7, the gating insert 3 as well as the carriage insert 11 in each case there are drillings 22 which are intended to convey a tempering medium, especially a cooling medium.

For the movement of the carriage 10 in the direction of the arrow Pin FIG. 1 a linear drive not shown in the figure can be designated, being operable electrically, mechanically, pneumatically or hydraulically according to the state of the art.

The tempering element 7 is of particular relevance for the quality of the surface of the resulting profile or the ledge to be produced 21 being in contact with the tempering element. The heatable part 7b of the tempering element 7 behind the gating insert 3 facilitates keeping the molding compound at a temperature level just slightly below the injection temperature. It can be considered as particularly advantageous to be able to variably temper the part 7b of the tempering element 7 during the injection sequence. The part 7d of the tempering element 7 which is prior to the gating insert 7 can be kept relatively cool.

FIG. 1 shows the already closed mold directly before the beginning of the injection sequence. The carriage 10 with the carriage insert 11 is in its initial position, the gating point is near the frontal end of the cavity 4. The carriage 10, the carriage insert 11, the tempering element 7 and the gating insert 3 form the boundary of the closed end section 4a of the mold cavity 4.

FIG. 2 shows the begin of the injection sequence. The injection unit 6 is attached to the hot runner nozzle 2, plastified molding compound 20 already has been injected into the section 4a. The gating insert is tempered such that a solidification of the molding compound during the filling process is prevented.

In a first step the section 4a is totally filled, with the molding compound finally advancing to the heated part 7b of the tempering element 7. In doing so the molding compound builds up a certain counter pressure to the injection pressure. The injection pressure is set up in such a way that at the part 7b of the tempering element 7 a free melt front 20a emerges which in and against the direction of translation of the carriage 10 cannot advance beyond the extension of the tempering element 7. Then the translation of the carriage 10 in the direction of the arrow P (FIG. 1 to FIG. 5) is started.

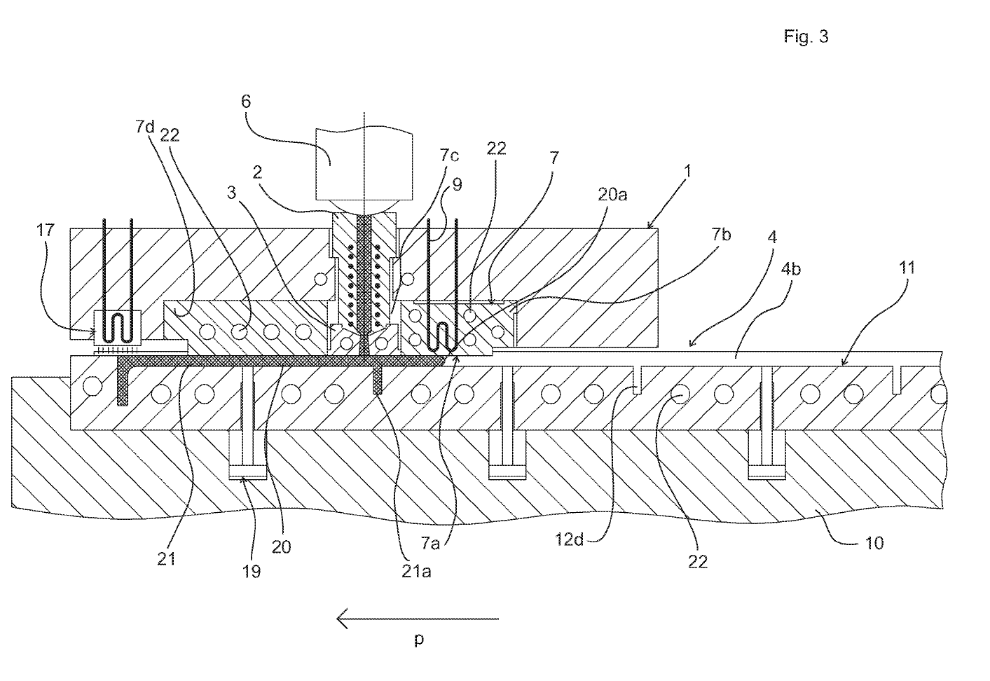

FIG. 3 shows a next stage during the continuous process of injection of molding compound 20. The free volume in the cavity 4 generated during the translation of the carriage 10 is steadily filled by the molding compound 20, said molding compound steadily flowing in. The process pressure is kept on a constant level causing the position of the melt front 20 underneath the heated part 7b of the tempering element 7 to stay at least substantially constant. That way a pseudo steady filling condition is reached.

As already mentioned the temperature at the tempering element 7 is kept on a level that keeps the molding compound 20 above solidification temperature in order to prevent prevent a solidification during the filling stage. The molding compound 20 that is moved away from the gating point by the carriage 10 leaves the closed section 4a and is cooled in the cooled pat 7d of the tempering element 7. The profile or ledge 21, that together with the carriage 10 continuously leaves the mold is after-treated by the after-treatment unit 17 at its free surface in order to assure the required quality of the resulting profile or the resulting ledge 21.

This after-treatment can include a treatment with infrared radiation, ultra sonic waves, flame treatment, laser radiation or similar. Also a mechanical after-treatment is possible by planning, sanding or grinding. That way it is possible not only to smoothen the surface of the formed profile or the formed ledge but also to structure or if necessary to deburr said surface.

FIG. 4 shows the further advancement of the production of the profile or the ledge 21. If for forming the ribs or crossbeams 21a in the profile or ledge 21 locally more molding compound is to be applied, the process pressure is increased accordingly by the closed loop control of the injection process. The closed loop control and control, respectively, of the movement of the carriage 10 relative to the mold insert is done by the machine control unit. There the injection parameters relevant for the process (pressure, temperatures, process times, strokes) are controlled depending on the relative movement of the carriage 10.

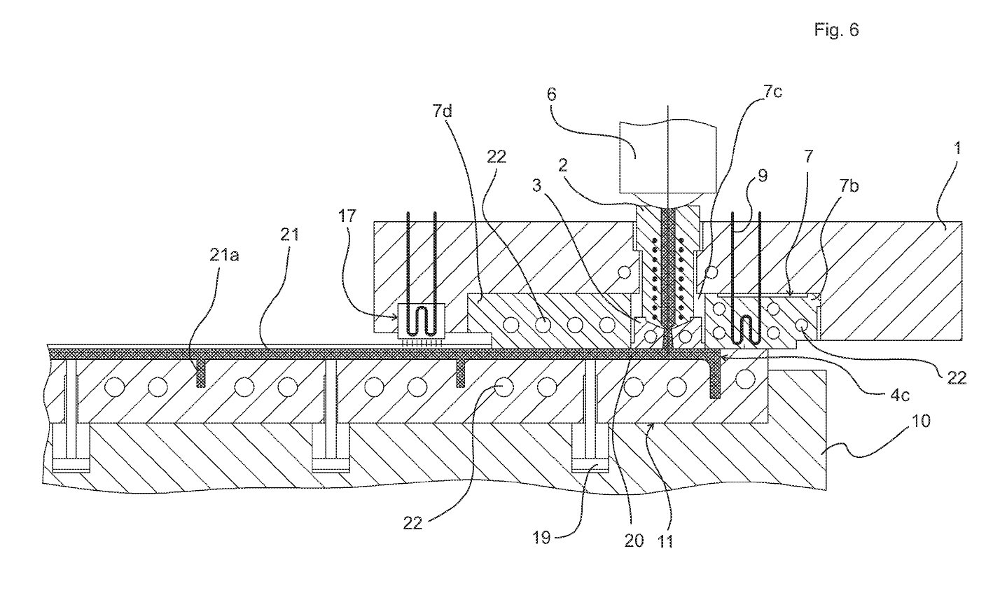

FIG. 5 shows a process stage during the formation of the profile or ledge 21 shortly before the molding compound fills the second end section of the cavity 4. FIG. 6. shows the last stage of the filling of the cavity 4 with filling up the recess 12b in the carriage insert 11, that way the second end cap of the profile or ledge being generated. As at a conventional injection molding process a holding pressure is kept up for a defined period in order to support or assure the proper forming of the profile or ledge at the designated end of the part.

Subsequently the profile or ledge 21 is cooled in the carriage insert 11 for a certain period of time in order to assure its solidification. The mold is opened and the profile or the ledge 21 is ejected by an ejector system 19 as state of the art at conventional injection molds.

At the embodiment of the invention shown in the figures the carriage 10 is translated relatively to the mold insert 1. It also is possible to position the profiled mold insert 1 at a fixed and not movable part of the mold and to translate the mold insert 1 at the nozzle side of the mold together with the injection unit 6 relatively to the mold insert. Carriage and carriage insert can be designed as one single part, while a design with a mold insert offers the advantage of interchangeability of the insert. The carriage can be designed segmented or as a multi part carriage, wherein components of the carriage can positioned on the upper part of the mold as well as on the lower part of the mold. The embodiment of the single components of the mold can also be done such that no straight, linear movement occurs but the mold insert at the nozzle side of the mold is moved along a 3-dimensional path in order to produce constantly or irregularly curved profiles or ledges. It is also possible and economically advantageous to inject into the profiled mold insert during the forward motion and during the backward motion of the carriage. This reduces the unoccupied times and thus the production cycle times. The injection into several cavities connected in series or connected in parallel is also possible.

The injection unit 6 can be equipped with one or more barrel(s), which are arranged in series or in parallel. If arranged in series different molding compounds for the production of multi-component parts or equal materials, in order to increase the shot volume, can be applied. A particularly advantageous mode of operation is the application of two or three injection cylinders that operate in an alternating or in a cyclic mode. There one injection cylinder injects molding compound into the mold while in the other cyclinder(s) new molding compound is plasticized. At unequally distributed injection and metering times three cyclinders can be of advantage. If several cyclinders are applied the melt streams are joined in a nozzle with control valve. The control of the injection process is preferably done depending on the injection pressure also a time or stroke dependent process control is possible. The operation mode with alternating injection units enables the production of very long profiles or ledges with high volumes with small injection units. Thus due to the low clamp force demand the machines can be built very small, also small aggregates can be applied for production cells in accordance with the invention.

The rheological layout of the process and the mold, respectively, is preferably done with simulation software. This could be enhanced software packages based on programs that are typically applied for injection molding process simulation. The development of customized program modules can be considered as beneficial for the simulation of the process in accordance with the invention.

In analogy to the process and the mold known from WO 2006/045720 the design of the mold can also comprise a core in order to be able to manufacture special part geometries.

As molding compound for the process in accordance with the invention mainly a thermoplastic material is to be considered which in molten condition is injected into the mold under temporarily defined influence of pressure and temperature and which solidifies in the mold due to freezing of the molten material. The molding compound can also be a reactive liquid, exemplarily a thermoset or an elastomer, which can be injected into the mold in analogy to a thermoplastic material but which solidifies due to chemical reaction. Thermoplastic molding compounds can be reinforced with fibers, for example with glass fibers. The process pressure at the injection process corresponds to levels customary to the pressure levels at conventional injection molding. Also inlay-parts or inserts made out of other materials such as glass, metals, composites or wood can be applied for the production of hybrid profiles or ledges. There the inserts are overmolded when the molding compound is continuously injected and a positive fit connection with said inlays is established. By the application of decorative films, textiles and veneers as cavity inlays components with decorated surface can be produced with the process according to the invention.

### REFERENCE NUMERALS

1 . . . Mold Insert

2 . . . Hot runner nozzle

3 . . . Gating insert

3a . . . Outer surface

4 . . . Mold cavity

4a . . . Closed end section

4b . . . Open end section

4c . . . Closed end section

5 . . . Recess

6 . . . Injection unit

7 . . . Tempering element

7a . . . Outer surface

7b . . . Heated part

7c . . . Opening

7d . . . Cooled part

9 . . . Heating element

10 . . . Carriage

10a . . . Recess

11 . . . Carriage insert

11a . . . Jaws

12a . . . Recess

12b . . . Recess

12c . . . Hollow section/void

12d . . . Recess

17 After-treatment unit

18 . . . Sliding element

19 . . . Ejector unit

20 . . . Molding compound

20a . . . Melt front

21 . . . Profile

21a . . . Cross beams

22 . . . Drilling

1. A method for forming elongated profiles or ledges out of solidifying molding compounds by the means of a mold with at least one lower and at least one upper part of the mold, with molding compound steadily injected into a cavity, with the injected molding compound transported away from the gating point(s) and out of the mold, respectively, under proceeding continued elongation of the formed profile or the formed ledge by relative movement of mold components and wherein molding compound is injected until the profile or ledge reaches its designated length,
characterized in that
at the beginning of the injection process the molding compound fills up an end section of the cavity of the profile or ledge to be formed, said end section closed in direction of the exit of the profile, beyond the gating point, wherein beyond the gating point due to the process pressure the front section of the molding compound during the relative movement of the mold components remains in position in relation to the upper part of the mold, as free front section of the molding compound, wherein the mold cavity is filled up while molding compound is transported away from the gating point and out of the mold.

2. The method according to claim 1, wherein the free front section of the injected molding compound is tempered separately.

3. The method according to claim 2, wherein the free front section of the injected molding compound is constantly tempered.

4. The method according to claim 2, wherein the free front section of the injected molding compound is tempered variably.

5. A mold for the production of elongated profiles or ledges out of solidifying molding compounds with at least one upper part of the mold and at least one lower part of the mold, wherein at one part of the mold at least one gating insert is attached and at the other part of the mold a profiled mold insert is attached which determines the geometry of the profile or ledge at least to a large extend and which is a part of the cavity, wherein the profiled mold insert and the part of the mold comprising the gating insert are moveable relatively to each other in direction of the longitudinal axis of the cavity such that due to the movement the profile or the ledge can be manufactured inside and outside the mold in the designated length,
characterized in that
the profiled mold insert comprises a cavity that corresponds to the length of the profile or ledge to be produced and together with the mold part comprising the gating insert only at the beginning and at the end of the injection process forms closed cavity end sections.

6. The mold according to claim 5, wherein the part of the mold comprising the gating insert contains a tempering element that gets in contact with the surface of the injected molding compound.

7. The mold according to claim 6, wherein the tempering element can be cooled at least in front of the gating point.

8. The mold according to claim 6, wherein the tempering element behind the gating point can be tempered in a variable way.

9. The mold according to claim 5, wherein the profiled mold insert comprises a movably supported carriage, which contains a profiled insert, said insert designed in a single-part or a multi-part design.

10. The mold according to claim 5, wherein said mold comprises an after-treatment unit for the treatment, especially for smoothening, of the free surface of the profile or ledge exiting the mold.

11. The mold according to claim 10, wherein the after-treatment is carried out with infrared radiation, ultrasonic waves, flame treatment or mechanical finishing.

12. Component, especially a profile or a ledge that is manufactured according to claim 1.
